(19) United States
(12) Patent Application Publication
(10) Pub. No.: US 2017/0322118 A1
(43) Pub. Date: Nov. 9, 2017

(54) METHOD FOR DETERMINING A STRUCTURAL STATE OF A MECHANICALLY LOADED UNIT

(71) Applicant: Bombardier Transportation GmbH, Berlin (DE)

(72) Inventors: Roland SPERLING, Attendorn (DE); Guido BIEKER, Kirchhundem (DE); Claus-Peter FRITZEN, Wilnsdorf (DE); Wolfgang Richter, Netphen (DE); Miguel Angel Torres Arredondo, Augsburg (DE)

(21) Appl. No.: 15/522,748

(22) PCT Filed: Oct. 30, 2015
(86) PCT No.: PCT/EP2015/075294

§ 371 Date: Apr. 27, 2017

(30) Foreign Application Priority Data
Oct. 30, 2014 (EP) PCT/EP2014/073393

(51) Int. Cl. G01M 17/10

(52) U.S. Cl. CPC G01M 17/10

(57) ABSTRACT

A structural state of at least one component of a mechanically loaded target unit, in particular a target unit of a rail vehicle, can be determined by introducing, in an actual excitation step of an evaluation cycle, a defined actual mechanical input signal into the target unit, capturing, in an actual capturing step of the evaluation cycle, an actual mechanical response signal of the target unit to the mechanical input signal, and comparing, in an actual evaluation step of the evaluation cycle, the actual mechanical response signal to a previously recorded baseline signal to establish an actual differential feature and using the actual differential feature to determine the structural state. The baseline signal is representative of a previous mechanical response signal of the target unit to a previous mechanical input signal.

### BACKGROUND OF THE INVENTION

The present invention relates to a method for determining a structural state of at least one component of a mechanically loaded target unit, in particular a target unit of a rail vehicle. The method comprises, in an actual excitation step of an evaluation cycle, introducing a defined actual mechanical input signal into the target unit, in an actual capturing step of the evaluation cycle, capturing an actual mechanical response signal of the target unit to the mechanical input signal, and, in an actual evaluation step of the evaluation cycle, comparing the actual mechanical response signal to a previously recorded baseline signal to establish an actual differential feature and using the actual differential feature to determine the structural state. The baseline signal is representative of a previous mechanical response signal of the target unit to a previous mechanical input signal, the previous mechanical input signal having a defined relation to the actual mechanical input signal. The present invention also relates to a corresponding system for determining a structural state of at least one component of a mechanically loaded target unit as well as a target unit implementing the system.

For nearly countless applications with structural components (i.e. any components made of one or more solid bodies), that are subject to mechanical loads, in particular, components having safety relevant functions, there is an obvious need to verify the actual structural integrity or wear situation as well as the position of the component in its lifecycle from time to time in order to ensure proper operation and timely prevention of potentially hazardous situations.

More precisely, it is desirable to evaluate, continuously or from time to time, the actual structural integrity of components in order to ensure timely prevention of potentially hazardous situations. Similar applies with respect to the state of wear of the component as well as the wear behavior in regard to defined maintenance intervals.

Hence, in the past, structural units forming or containing such components have been subject to periodic non-destructive inspection to perform this verification. Initially, such inspection had been done mainly visually and/or acoustically by well trained experts. Over time, however, more sophisticated automated or semi-automated non-destructive inspection methods have been developed to more properly and reliably evaluate the actual structural state of such components.

One common non-destructive inspection concept is introducing ultrasound waves into the structure to be examined and analyzing the dynamic response signals or echo signals, respectively, captured via one or more sensors mounted to the structure. Typically, the response signals are compared to so-called baseline signals captured at an earlier point in time for the same component or a reference component of identical design in a new and (presumably) pristine state. From the differences detected between the actual response signals and the baseline signals conclusions may be drawn on the actual damage status of the examined component.

For example, a structural damage, such as a crack within the structure causes abnormal scattering (i.e. scattering not occurring in a pristine or flawless structure) of the ultrasound waves introduced into the structure. Such abnormal scattering obviously causes a modification to the response signals actually captured compared to the baseline signals. A major problem in properly identifying such a damage situation is the highly complex nature of the captured response signal. This circumstance is due to several influencing factors influencing signal overlay and blurring, respectively. Primary influencing factors are, for example, the complexity of the geometry of the structure itself causing multiple reflections, the different modes of propagation of the waves within the structure etc. Secondary influencing factors are, for example, variations in the temperature of the component, which have a severe influence, both on the geometry of the structure due to thermal expansion effects but also on the speed of propagation of the waves.

Hence, many more or less complex and sophisticated methods have been developed for properly identifying and even localizing damage by comparing such captured response signals with baseline signals. Multiple examples of such methods are described by Michaels (“Detection, localization and characterization of damage in plates with an in situ array of spatially distributed ultrasonic sensors”, in Smart Materials and Structures 17, 2008, 035035, 15pp; 10P Publishing Ltd, G B, 2008) and Torres-Arredondo et al. (“Damage detection and classification in pipework using acousto-ultrasonics and non-linear data-driven modelling” in Journal of Civil Structural Health Monitoring, ISSN 2190-5452, DOI 10.1007/s13349-013-0060-5, Springer-Verlag Berlin Heidelberg, D E, 2013).

All these known methods have been established for fairly simple structures, such as planar plates (see Michaels) and straight cylindrical tubes (see Torres-Arredondo et al.). Hence, while general applicability of these methods is demonstrated, transfer of these methods to more complex structures is a non-trivial task, which renders the systems to be established for this task even more complex.

### BRIEF DESCRIPTION OF THE INVENTION

The object for the present invention was therefore to provide a method of the type mentioned initially, which does not or at least to a lesser degree have the disadvantages mentioned above, and which, in particular, in a simpler and reliable manner allows determination of the structural state of units of more complex design.

The present invention solves this problem on the basis of a method according to the preamble of claim 1 by means of the features indicated in the characterizing part of claim 1. It also solves this problem on the basis of a system according to the preamble of claim 11 by means of the features indicated in the characterizing part of claim 10.

The present invention is based on the technical teaching that simpler and yet reliable determination of the structural state of a target structure of more complex design may be achieved if, instead of the known assessment of the structural state performed exclusively on the basis of a difference between the actual mechanical response signal to a previously recorded baseline signal (also referred to as the differential features of these two signals in the following), the assessment is done on the basis of the development of this difference over time.

More precisely, it has been recognized that, for many applications, absolute assessment of the degree and/or location of damage and/or wear of a component (as known methods try to establish it) at a certain point in time is less critical or important than properly identifying that a certain modification of the structural state (which modification has a certain defined quality) has actually occurred since the last evaluation. Hence, rather than trying to establish an exact identification and quantification of damage and/or wear with respect to a (known or, rather, presumed) pristine state of the structure, the present invention relies on analyzing or tracking, respectively, the changes in the differential features of these signals over time in order to classify the structural state.

This approach has the great advantage that it does not require complex exact quantification of the damage and/or wear, which renders known systems so highly complex and sensitive to errors in the inevitable initial assumptions (such as a perfect initial structural integrity). Rather, detection of characteristic alterations in the differential features may provide reliable detection and classification of changes in the structural state without the need of expensive exact quantification of the structural condition itself. For example, a sudden jump or step, respectively, in the respective differential features is a reliable hint that damage, such as a crack, has occurred in the target structure between the two evaluation cycles considered.

Moreover, this approach does not only allow identification and classification of damage but also the identification and classification of wear. More precisely, certain behavior of the differential feature over time may be clearly related to the wear of the target structure, even to specific components of the target structure. For example, an increasing inclination in the course of the differential feature over time may be a clear indication that a certain critical wear status has been reached, which requires appropriate reaction to avoid failure of the structure or the like.

It will be appreciated that in either case (damage and wear evaluation) typical patterns of the course of the differential feature over time may be easily established for the specific structure. These typical patterns allow classification and even correlation of the current situation (as detected) with specific states of individual components and/or locations within the target structure. Hence, for example, from typical differential feature patterns (previously established for the target structure), it may be derived that the currently established actual development of the differential feature is (at least most likely) related to damage of a specific part of the target structure at a specific location within the target structure. It will be appreciated that, to this end, suitable and generally know pattern recognition algorithms may be used.

Given the above, it should be noted at this point that, in the sense of the present invention, the structural state of a component includes any property of the component (relating e.g. to the component's internal or external structural integrity and/or its material properties and/or its geometric properties etc.), which may be affected and altered, respectively, by damage and/or wear, respectively.

Hence according to a first aspect, the present invention relates to a method for determining a structural state of at least one component of a mechanically loaded target unit, in particular a target unit of a rail vehicle, the method comprising, in an actual excitation step of an evaluation cycle, introducing a defined actual mechanical input signal into the target unit, in an actual capturing step of the evaluation cycle, capturing an actual mechanical response signal of the target unit to the mechanical input signal, and, in an actual evaluation step of the evaluation cycle, comparing the actual mechanical response signal to a previously recorded baseline signal to establish an actual differential feature and using the actual differential feature to determine the structural state. The baseline signal is representative of a previous mechanical response signal of the target unit to a previous mechanical input signal, the previous mechanical input signal having a defined relation to the actual mechanical input signal. In an actual differential feature comparison step of the actual evaluation step, the actual differential feature is compared to at least one reference to determine the structural state, wherein the at least one reference is established from at least one previous differential feature, the at least one previous differential feature having been previously established for the target unit in a previous execution of the evaluation cycle.

It shall be noted here that, in the sense of the present invention, the term “signal” is to be understood in a broad sense as data representing the content of information of the respective capturing action, irrespective of the actual form of representation of the information. Furthermore, the term “differential feature” shall encompass any information obtained from the comparison between the actual mechanical response signal and the baseline signal, again irrespective of the actual form of representation of the information. Typically, the differential feature is an expression that compares the actual mechanical response signal and the baseline signal and is equal to zero if the actual mechanical response signal and the baseline signal are identical.

It will be appreciated that the actual mechanical response signal and the previous mechanical response signal may have been captured along identical signal paths within the target component allowing simple comparison. With certain embodiments, however, the actual mechanical response signal and the previous mechanical response signal different signal paths are captured along different signal paths, e.g. along paths from deviating locations of excitation and/or to deviating capturing locations, eventually only in opposite directions. Such an approach may be helpful in gathering further information regarding the actual structural state.

It will be appreciated that the actual differential feature may be compared to one single previous differential feature forming the reference. With certain preferred embodiments, however, the reference is established using a plurality of such previously established differential features. This historic approach (considering a longer history of the differential feature) allows even more refined analysis of the current situation.

It will be appreciated that, with certain embodiments, the actual differential feature and the previous differential feature are established using a fixed baseline signal, i.e. the same baseline signal in both cycles of evaluation. Preferably, a floating baseline signal is used, i.e. a baseline signal that is modified over time. Such a floating baseline signal, among others, has the advantage that low speed modifications in the evaluation system, such as drift effects, become less critical. Hence, preferably, in a baseline setting step after the actual evaluation step, the actual mechanical response signal is set as the baseline signal to be used in a subsequent evaluation step to form a floating baseline signal.

As mentioned above, the comparison may be done exclusively with one single previous differential feature. Hence, in these very simple cases, the at least one reference is formed exclusively from the previous differential feature. With other embodiments, however, the at least one reference is formed from a plurality of previous differential features including the previous differential feature, each of the plurality of previous differential features having been previously established for the target unit in a plurality of previous executions of the evaluation cycle. In these cases, as mentioned above, a history of the differential feature is considered, which allows simpler and more precise classification of the actual structural state of the target unit.

It will be appreciated that any previous differential feature may be used in the actual evaluation step. Preferably, however, the differential feature last established prior to the actual evaluation step is used. Hence, with certain embodiments, the previous differential feature has been established in an immediately preceding previous execution of the evaluation cycle.

Furthermore, in case of a historic approach, preferably, each of the plurality of previous differential features has been established in a different previous execution of the evaluation cycle. Here again, any desired sequence of previous differential features may be used, which must not necessarily coherent. Preferably, however, each of the plurality of previous differential features has been established in a continuous series of previous executions of the evaluation cycle.

With certain embodiments of the invention, the at least one reference is established by extrapolation from the plurality of previous differential features. By this means it is possible, for example, to establish a reference differential feature that is expected, at the point in time of the establishment of the actual differential feature, in view of the history of the previous differential features. If, for example, the actual differential feature noticeably deviates from the expected reference differential feature to an extent that goes beyond normal tolerances, damage is likely to have occurred, that causes this abnormal deviation. Hence, preferably, the at least one reference is an expected reference differential feature established, in particular, by extrapolation, from the plurality of previous differential features.

With certain embodiments of the invention the previous differential feature has been established using at least one comparison target unit under comparison boundary conditions having a defined relation to boundary conditions under which said actual differential feature is established. By this means it is possible to determine the structural state of the target unit not only by looking at the target unit itself but by a comparison to one or more other, typically at least similar or substantially identical, units analyzed under sufficiently well-known comparison boundary conditions (i.e. boundary conditions, the relation of which to the actual boundary conditions of the target unit is sufficiently well known). For example, one or more identical units of a rail vehicle (e.g. consecutive wheel sets etc.), typically undergoing at least similar mechanical loads, may be used as comparison target units.

Preferably, the comparison boundary conditions are substantially identical to the actual boundary condition, which makes comparison particularly easy. However, with other variants, the comparison boundary conditions and the actual boundary conditions may even substantially deviate as long as the influence of this deviation on the determination of the structural state is sufficiently well known, such that it can be taken into account when determining the structural state of the target unit.

With preferred embodiments of the invention, in a classification step of the actual evaluation step, the structural state is classified as a function of a result of the comparison between the actual differential feature and the at least one reference. As mentioned above, classification may be done according to various approaches. In typical cases, a pattern recognition algorithm may be used to provide classification.

Preferably, in a logging step after the classification step, at least the actual differential feature and/or the at least one reference and/or the classification established in the classification step is stored, in particular, for use in later data analysis and/or use in the determination of a subsequent reference, in particular, for extrapolation of the expected reference differential feature.

Preferably, the result of the classification triggers a suitable reaction as a function of the outcome of the classification. Hence, with preferred embodiments of the invention, in a reaction step after the classification step, a reaction is initiated as a function of the classification established in the classification step. The reaction maybe of any suitable type, e.g. an automatic alarm notification to an operator of the target unit, in case of the detection of a damage, in particular, in case of potentially hazardous damage. Furthermore, depending on the safety level of the target unit, the reaction may immediately influence operation of the target unit, such as automatic shutdown of the target unit in case of potentially hazardous situations. Hence, preferably, the reaction comprises a notification of the classification and/or a modification of an operational state of the target unit.

Classification of the structural state may be done according to any desired and suitable classification method. With certain preferred embodiments, the structural state is classified as a damaged state if a deviation between the actual differential feature and the at least one reference exceeds a damage threshold, the damage threshold being a maximum wear differential feature representative of a maximum wear to be expected at the point in time of the actual capturing step.

With certain further embodiments, the structural state is classified as a damaged state if a speed of alteration of the actual differential feature with respect to the at least one reference exceeds a damage threshold speed, the damage threshold speed being a maximum speed of alteration to be expected at the point in time of the actual capturing step. Hence, in a simple manner, unexpected steps or jumps in the differential feature are classified as a damage situation.

In addition or as an alternative, the structural state is classified as an excessively worn state if a deviation between the actual differential feature and the at least one reference exceeds a normal wear threshold, the normal wear threshold being a normal wear differential feature representative of a normal wear to be expected at the point in time of the actual capturing step. In other words, if the deviation in the differential feature exceeds a threshold that is expected under normal wear conditions, it may be assumed that such an excessively worn situation is present.

Similarly, in other embodiments, an excessively worn situation may be presumed if the differential feature increases faster than expected under normal wear conditions. Hence, preferably, the structural state is classified as an excessively worn state if a speed of alteration of the actual differential feature with respect to the at least one reference exceeds a normal wear threshold speed, the normal wear threshold speed being a speed of alteration to be expected at the point in time of the actual capturing step under normal wear conditions.

It will be appreciated that, with certain embodiments, in particular, embodiments with sufficiently stable boundary conditions, the differential feature may simply be taken as it is determined in the evaluation step. With certain embodiments, however, having less stable boundary conditions, a deviation in relevant boundary conditions between the actual cycle and relevant previous cycles (considered in the actual evaluation step) is taken into account.

Hence, preferably, in an boundary condition assessment step, an actual value of at least one boundary condition parameter influencing the actual mechanical response signal is determined, and in a correction step prior to the actual differential feature comparison step, the actual mechanical response signal is corrected as a function of a difference in the actual value of the at least one boundary condition parameter and a recorded value of the at least one boundary condition parameter determined at the point in time of the previous execution of the evaluation cycle, in particular, at the point in time of the excitation step and/or the capturing step of the previous execution of the evaluation cycle.

It will be appreciated that any boundary condition parameter relevant to the results of the evaluation step may be taken into account. Preferably, the boundary condition parameter is at least one temperature of the target unit and/or of an atmosphere surrounding the target unit and/or a temperature distribution of the target unit and/or of an atmosphere surrounding the target unit and/or at least one mechanical load, in particular, a mechanical load distribution or a load collective, respectively, acting on the target unit and/or a mechanical stress, in particular, a mechanical stress distribution, present in the target unit and/or a mechanical strain, in particular, a mechanical strain distribution, present in the target unit, and/or a vibration frequency spectrum of the target unit and/or a position and/or an orientation of at least one component of the target unit and/or a humidity of the target unit and/or a humidity of an atmosphere surrounding the target unit. Furthermore, in addition or as an alternative, the boundary condition parameter may be a viscosity of an atmosphere surrounding the target unit and/or a density of an atmosphere surrounding target unit and/or a flow rate of an atmosphere surrounding the target unit. This evaluation of the surrounding atmosphere may be particularly useful if the mechanical influence of the atmosphere (e.g. a mechanical damping influence) possesses relevance to the evaluation of the structural state. This may, for example, be the case if the atmosphere is a liquid atmosphere. Such relevance may, however, also exist with a surrounding gas atmosphere or combinations of such atmospheres. A modification in any of these parameters, typically, has a non-negligible effect on the results of the evaluation step, such that particularly good results are achieved if they are taken into account.

It will be appreciated that, basically, any desired approach may be used to establish the relevant boundary condition parameters. For example, direct measurement (e.g. by one or more suitable sensors) of the actual value of the relevant boundary condition parameter(s) may be used. Preferably, a model based approach is used to provide in a simple manner a suitably fine resolution of the boundary condition parameter matching the sensitivity of the evaluation process to variations in the boundary condition parameter. Preferably, the boundary condition parameter is established using at least one input value representative of the boundary condition parameter and a model of the target unit, the model providing a distribution of the boundary condition parameter over at least a part of the target unit as a function of the at least one input value, the model, in particular, being a temperature model of the target unit providing a temperature distribution over at least a part of the target unit as a function of the at least one input value, the at least one input value, in particular, being at least one temperature value captured at the target unit or in a vicinity of the target unit.

With further advantageous embodiments of the invention, the actual differential feature has been established at a first value of the at least one boundary condition parameter and the at least one reference has been established at a second value of the at least one boundary condition parameter. In a classification step of the actual evaluation step, the structural state is classified as a function of a difference between the first value of the at least one boundary condition parameter and the second value of said at least one boundary condition parameter. Hence, in other words, advantage may be taken from the fact that the actual differential feature and the reference have been established at different values of the at least one boundary condition parameter. With certain other embodiments of the invention, however, it is tried to keep the first and second value of the at least one boundary condition as close as possible (preferably substantially identical).

With advantageous embodiments of the invention, in a damage localization step of the actual evaluation step, in case of a classification of the structural state as a damaged state, a damage localization step is executed using at least the actual mechanical response signal. In addition or as an alternative, in an excessive wear localization step of the actual evaluation step, in case of a classification of the structural state as an excessively worn state, an excessive wear localization step is executed using at least the actual mechanical response signal. In both cases, localization of the damaged or worn part of the target structure may be achieved.

It will be appreciated that any desired and suitable localization method may be executed. In particular, it will be appreciated that the localization step may be executed using more than one actual mechanical response signal detected by more than one signal detectors and generated by one or more signal generators. Moreover, a pulse-echo technique including an elapsed time measurement may be used. Furthermore, any of the methods generally described in Michaels and Torres-Arredondo et al. (as mentioned initially) may be executed (alone or in arbitrary combination).

Preferably, the localization step is executed using a difference between the actual mechanical response signal and at least one previous mechanical response signal of the target unit, the at least one previous mechanical response signal having been established using a different, in particular inverted, signal path through the target unit. By this means particularly simple localization may be achieved. As an alternative, the localization step may be executed using a difference between the actual differential feature and at least one previous differential feature established for the target unit, the at least one previous differential feature having been established using a different, in particular inverted, signal path through the target unit. By any of these means particularly simple localization may be achieved.

In addition or as an alternative, the localization step may be executed by comparing the actual mechanical response signal and at least one modeled mechanical response signal, the at least one modeled mechanical response signal having been established using a model of the target unit. By this means simple localization may be achieved by identifying one or more deviations from an expected (modeled) situation which are characteristic for specific damage and/or wear at specific locations.

In addition or as an alternative, the localization step is executed using damage pattern recognition algorithm, the damage pattern recognition algorithm comparing the actual mechanical response signal to a plurality of damage patterns previously established for the target unit, each of the damage patterns representing a damage mechanical response signal to be captured in response to the mechanical input signal upon a specific damage introduced at a specific location in the target unit. A similar approach may be taken for wear localization. By this means a very simple and reliable localization may be achieved.

It will be appreciated that basically any desired and suitable starting point may be used for the present method. More precisely, it is not absolutely necessary that the reference used is representative of the new and pristine state of the target unit. Hence, in certain cases, the method may be applied to the target unit at any point in its lifecycle.

Preferably, however, the at least one previous differential feature has been previously established using an initial baseline signal, the initial baseline signal being a mechanical response signal of the target unit to the previous mechanical input signal in a new and undamaged or unworn state.

As mentioned above, the differential feature is representative of a deviation between the actual mechanical response signal and the baseline signal. Basically, any expression providing corresponding information may be used. Preferably, the differential feature is a normalized squared error between the actual mechanical response signal and the baseline signal and/or a drop in a correlation coefficient between the actual mechanical response signal and the baseline signal and/or a drop in a correlation coefficient between the actual mechanical response signal and the baseline signal and/or a feature obtained from Principal Component Analysis (PCA), in particular, Nonlinear Principal Component Analysis (NLPCA), in particular Hierarchical Nonlinear Principal Component Analysis (h-NLPCA), and/or a feature obtained from Independent Component Analysis (ICA). Some of these options have been described in Michaels (as mentioned initially) and provide, in a fairly simple manner, proper information on the deviation between the actual mechanical response signal and the baseline signal. Furthermore, in a beneficial way, use one or more characteristic features of the respective signal (such as e.g. frequency and/or amplitude and/or phase) for the comparison, which greatly facilitates the process.

With preferred embodiments of the invention, proper information may be obtained, if the differential feature is a feature obtained from at least one of the following methods or approaches, namely difference formation in the time domain, phased adjusted difference formation in the time domain, difference formation in the frequency domain, cross-correlation, signal time-of-flight analysis, regression analysis, Kalman filter analysis, pattern recognition analysis, self-organizing maps (SOM), support vector machines (SVM), neuronal networks, multi-variant methods, such as cluster analysis, multi-dimensional scaling (MDS) and null-subspace analysis.

Similarly, with preferred embodiments of the invention, proper information may be obtained, if the differential feature is a feature obtained using digital filtering, in particular, using Bessel filters and/or Butterworth filters and/or Tschebyscheff filters, and/or using analog processing, in particular, analog filtering prior to A/D conversion.

With further preferred embodiments of the invention, the actual mechanical response signal may also already be a correlated mechanical response signal generated from at least two immediately consecutive instantaneous mechanical response signals captured by at least one signal detector, preferably at least two different signal detectors. The immediately consecutive instantaneous mechanical response signals are captured and then correlated in any suitable way, e.g. by cross correlation or even simple subtraction, to yield the actual mechanical response signal, which is then used for establishing the differential feature as described herein.

In a simple first variant of this case, for example, the two immediately consecutive instantaneous mechanical response signals are generated and captured using two mechanical wave generator and detector units either one being adapted to generate an instantaneous mechanical input signal and capture an instantaneous mechanical response signal (resulting from the instantaneous mechanical input signal of the respective other generator and detector unit). It will be appreciated that the respective mechanical wave generator and detector unit may be formed by a single component (e.g. a single piezoelectric element acting as both the generator and the detector).

More precisely, in this example, the first mechanical wave generator and detector unit generates a first instantaneous mechanical input signal, while the second mechanical wave generator and detector unit captures the first instantaneous mechanical response signal (resulting from the first instantaneous mechanical input signal of the first generator and detector unit).

Then, after a response fading delay (which preferably is as short as possible but ensures that the first instantaneous mechanical response signal has sufficiently faded to avoid noticeable interference with the second instantaneous mechanical response signal), the signal path is inverted and the second mechanical wave generator and detector unit generates a second instantaneous mechanical input signal, while the first mechanical wave generator and detector unit now captures the second instantaneous mechanical response signal (resulting from the second instantaneous mechanical input signal of the second generator and detector unit).

The second instantaneous mechanical input signal has a defined relation to the first instantaneous mechanical input signal in order to allow proper correlation. Preferably, the second instantaneous mechanical input signal is substantially identical to the first instantaneous mechanical input signal.

Typically, in an undamaged and/or unworn state of the target unit, with substantially identical first and second instantaneous mechanical input signals, the first and second instantaneous mechanical response signals should be substantially identical, such that the output of the correlation of the first and second instantaneous mechanical response signal (forming the actual mechanical response signal, which is then used for forming the differential feature) should be substantially zero.

In a damaged and/or worn state of the target unit (unless the location of the damage and/or wear is at a point of symmetry of the signal path), the first and second instantaneous mechanical response signal will differ from each other. This yields a non-zero output of the correlation and, hence, a non-zero actual mechanical response signal. As damage and/or wear proceeds, the deviation between the first and second instantaneous mechanical response signal typically increases and so does the actual mechanical response signal (the used for forming the differential feature).

It will be appreciated that the response fading delay may be any suitable delay, which is short enough to avoid noticeable variations in the boundary conditions but ensures that the first instantaneous mechanical response signal has sufficiently faded to avoid noticeable interference with the second instantaneous mechanical response signal. Preferably, the response fading delay ranges from 0.01 s to 10 s, preferably from 0.1 s to 5 s, more preferably from 0.2 s to 2 s.

The above approach has the advantage that the first and second instantaneous mechanical response signal typically are taken at substantially the same boundary conditions, such that the actual mechanical response signal (as the result of the correlation of the first and second instantaneous mechanical response signal) and, hence, the differential feature generated using the actual mechanical response signal) is less sensitive to variations in these boundary conditions (as they have been outlined above). This particularly applies, for example, to the sensitivity to temperature variations.

It will be appreciated that, with certain embodiments of the more than two instantaneous mechanical response signals may be generated and captured along different signal paths and correlated to yield the actual mechanical response signal. This may be done by more than two (suitably distributed) mechanical wave generator and detector units.

In addition or as an alternative, in a second variant of the use of such correlated instantaneous mechanical response signals, the actual mechanical response signal may be a correlated signal generated from at least two mechanical response signals captured substantially simultaneously by at least two different signal detectors.

In this case, preferably, the at least two mechanical response signals may be the result of one instantaneous mechanical input signal generated by one mechanical wave generator unit. However, the two mechanical response signals may also be the result of at least two (preferably substantially simultaneously generated) instantaneous mechanical input signals (of defined relation) generated by at least two different mechanical wave generator units.

Here as well, the first and second instantaneous mechanical response signal are taken at the same boundary conditions, such that the actual mechanical response signal (as the result of the correlation of the first and second instantaneous mechanical response signal) and, hence, the differential feature generated using the actual mechanical response signal) is less sensitive to variations in these boundary conditions (as they have been outlined above). This particularly applies, for example, to the sensitivity to temperature variations.

It will be appreciated that, in this second variant as well, the mechanical wave generator unit generating the instantaneous mechanical input signal may also be a mechanical wave generator and detector unit, capturing the echo of its instantaneous mechanical input signal as the second instantaneous mechanical response signal

In addition or as an alternative, in a third variant of the use of such correlated instantaneous mechanical response signals, the first and second instantaneous mechanical response signal may also be captured at definably different values of one or more boundary conditions (e.g.

at different load situations or at different rotating angles of a rotating component etc.). Here, the defined difference in the first and second value of the respective boundary condition is preferably used as a correlation parameter of the correlation.

For example, the correlation (yielding the actual mechanical response signal used for generating the differential feature) may then be made using e.g. the first instantaneous mechanical response signal as a reference to which the second instantaneous mechanical response signal (and eventually an further instantaneous mechanical response signal) is correlated.

It will be appreciated that, basically, any mechanical input signal may be used that is suitable for sufficiently long travel in the target structure. Preferably, the actual mechanical input signal is an ultrasound signal and/or a signal in a frequency range from 20 kHz to 20 MHz, preferably from 50 kHz to 1 MHz, more preferably from 80 kHz to 300 kHz. Further particularly suitable frequencies for structural state analysis lie in the range from 10 MHz to 20 MHz,

It will be appreciated however that, with other embodiments of the invention, frequencies below the ultrasound range may be used, even down to the audible range, e.g. down to about 16 Hz. This may, in particular, be the case if an otherwise functional component of the target unit (e.g. a brake of a vehicle etc.) is used as the mechanical wave generator. Likewise, with other embodiments of the invention, frequencies in the Terahertz range may be used.

It will be appreciated that the respective frequency range for the input signal used typically depends on the mechanical properties of the target unit and/or the type of damage or wear to be evaluated and/or the mechanical influence of the surroundings. Hence, preferably, a frequency of the actual mechanical input signal is selected as a function of a parameter of the target unit and/or a parameter of an atmosphere surrounding the target unit.

In particular, the size of the target unit, typically, has an influence on the frequency range. This is nonetheless due to the fact that smaller size components typically exhibit higher resonant frequencies than larger size components. Preferably, for larger size components (such as e.g. a wheel set shaft of a wheel set of a rail vehicle) a frequency range of the mechanical input signal is between 80 kHz to 160 kHz, while for smaller size components (such as e.g. a gear of a wheel set of a rail vehicle) a frequency range of the mechanical input signal preferably is between 160 kHz to 240 kHz. It will be appreciated however that, in particular depending on the target unit of interest and/or the type of damage or wear to be evaluated, higher or lower frequency ranges may also be used.

It will be appreciated that, basically, one single mechanical input signal of arbitrary suitable duration may be sufficient. With particularly efficient variants, the actual mechanical input signal comprises at least one input signal, in particular, an input burst signal, having a duration of up to 1 s, preferably up to 0.75 s, more preferably up to 0.5 s, in particular, 0.1 s to 0.5 s. Such comparatively short signals or signal bursts allow simple evaluation largely avoiding problems with echo overlay.

It will be appreciated that, basically, one single mechanical input signal introduced at one single location may be sufficient. Preferably, however, the actual mechanical input signal comprises a plurality of partial input signals, each partial input signal being introduced into the target unit at a different location of the target unit. Similarly, preferably, the actual mechanical response signal comprises a plurality of partial response signals, each partial response signal being captured, in particular substantially simultaneously, at a different location of the target unit.

Accordingly, preferably, at least one mechanical wave generator unit for generating the actual mechanical input signal and/or at least one mechanical wave detector unit for capturing the actual mechanical response signal is mechanically connected to the target unit. Mechanical connection of the respective generator unit or detector unit to the target unit may be done in any suitable way either permanently or via a carrier unit releasably connected to the target unit. Preferably, an array (or network) of mechanical wave generator units for generating the actual mechanical input signal and/or an array (or network) of mechanical wave detector units for capturing the actual mechanical response signal is mechanically connected to the target unit.

It will be appreciated that, with certain embodiments, the at least one mechanical wave generator unit and/or the at least one mechanical wave detector unit does not necessarily have to be connected directly to the target unit. Rather, a connection via further components of a structure, the target unit forms part of, may be sufficient as long as the signals are sufficiently properly guided to and/or from the target unit.

It will be appreciated that, with certain embodiments, the mechanical wave generator unit and the mechanical wave detector unit are configured to perform one or more self-testing routines to exclude artefacts caused by malfunctions of these components. Hence, preferably, at least one mechanical wave generator unit for generating the actual mechanical input signal and at least one mechanical wave detector unit for capturing the actual mechanical response signal is mechanically connected to the target unit, the at least one mechanical wave generator unit and the at least one mechanical wave detector unit, in a self-testing step, executing a self-test to assess their proper function.

It will be appreciated that the mechanical wave generator unit and the mechanical wave detector unit may be separate components or units, respectively. With certain embodiments, however, both functions are integrated in one single unit. Hence, in these cases, at least one mechanical wave generator and detector unit for generating the actual mechanical input signal and for capturing the actual mechanical response signal is mechanically connected to the target unit. In these cases the actual mechanical response signal may be captured as an echo signal, in particular directly after introducing the actual mechanical input signal, at the location of introduction of the actual mechanical input signal into the target unit.

It will be further appreciated that the mechanical wave generator unit may also be formed by a functional component of the arrangement, the target unit forms part of, which provides one or more further functions beyond generating the mechanical input signal. Basically, any component suitable for generating a defined (and preferably sufficiently reproducible) mechanical input signal may be used.

This may either be an active component, actively generating the respective mechanical input signal (under the control of a suitable controller) or a passive component generating or rather causing the respective mechanical input signal as a result of the operation of the arrangement. Generally, any component causing a defined energy input into the target unit may be used. For example, in a rail vehicle environment, such an active component (forming the mechanical wave generator unit) may be a drive motor or a brake unit generating such defined energy input. On the other hand, such a passive component (forming the mechanical wave generator unit) may be an imperfection in the drive train (e.g. a flattened spot on the wheel contact surface, a drive gear imperfection etc.) generating such defined energy input.

As mentioned above, the method according to the invention may be used in any desired environment. Particularly beneficial results may be achieved, for example, in a railway environment where monitoring of the structural state of many safety relevant components is to be achieved. Hence, with certain embodiments, the target unit is a unit of a rail vehicle, the target unit, in particular, comprising a wheel unit, in particular, a wheel set, and/or wheel unit shaft and/or wheel unit axle and/or a drive unit and/or a drive motor unit and/or a drive gear unit and/or a wheel bearing unit and/or a running gear frame unit and/or a wagon body unit and/or a suspension unit and/or a current collector unit and/or a compressor unit and/or an electrical equipment unit, in particular a transformer unit and/or a converter unit. Similarly, any further components of the rail vehicle, such as brackets, brakes, dampers, traction linkages, shoe gears etc. may form such a target unit.

Furthermore, implementation of the invention may be particularly useful in the monitoring of the wheel units of vehicles. Hence, in some cases, the target unit is a wheel unit, in particular, a wheel set, of a rail vehicle and at least one mechanical wave generator and/or at least one mechanical wave detector unit is connected to an end section of a wheel unit shaft of the wheel unit.

With other variants, the target unit is a unit of an airplane, in particular, a structural unit of a power train and/or a running gear and/or a bodywork of the airplane. For example, the target unit may be the bodywork or the body understructure or the landing flaps or the yaw rudders or elevons or elevators or a running gear or a jet engine or a fan or a mechanical flight control system or a motor or a pump or a landing gear or a wheel or a corresponding component or system of the airplane.

Furthermore, with other variants, the target unit is a unit of a motor vehicle, in particular, a structural unit of a power train and/or a running gear and/or a bodywork of the motor vehicle. For example, the target unit may be an automobile or a truck or a bodywork or a running gear or the motor or a corresponding component or system of the motor vehicle.

Furthermore, with other variants, the target unit is a unit of a ship, in particular, a structural unit of a power train and/or a bodywork of the ship. For example, the target unit may be a motor or a gear or a rudder system or a mast or a corresponding component or system of a ship.

Furthermore, with other variants, the target unit is a unit of a spacecraft, in particular, a structural unit of a bodywork or a corresponding component or system of the spacecraft. Alternatively, the target unit is a unit of a military tank, in particular, a structural unit of a power train or a running gear or a bodywork or a corresponding component or system of said military tank.

Alternatively, the target unit is a unit of a construction machine, in particular, a structural unit of a construction machine or a support structure of the construction machine or a corresponding component or systems of the construction machine. Alternatively, the target unit is a unit of an industrial machine, in particular, a structural unit of a power train and/or a support structure or a corresponding component or system of the industrial machine.

Furthermore, with other variants, the target unit is a unit of a building, in particular, a structural unit of a support structure of the building. With certain further embodiments, the target unit is a unit of a tubing network, in particular, at least one tube or a corresponding component or system (such as mountings, valves, pumps, aggregates) of the tubing network. With certain further embodiments, the target unit is a unit of a storage tank or pressure tank, in particular, at least one wall or a corresponding component or system of the storage tank or pressure tank.

Alternatively, the target unit is a unit of a wind energy plant, in particular, a structural unit of a pylon or a rotor of the wind energy plant. For example, the target unit may be an electrical equipment unit of the wind energy plant or a structural unit of a pylon or a housing or a gear or a rotor component or a corresponding component or system (such as gears, axles, drive shafts etc.) of the wind energy plant.

Finally, any other target units may be chosen, such as other power plant units, steel mills, cranes, agricultural machines as well as any desired components thereof.

It will be appreciated that the evaluation cycle may be initiated at any desired point in time and under any desired operational state of the vehicle. In particular, the evaluation cycle may be gone through during normal operation of the vehicle. Hence, with certain embodiments, at least one execution of the evaluation cycle ensues during normal operation of the target unit. However, with certain embodiments, at least one execution of the evaluation cycle may ensue during downtime of the target unit. This variant is particularly suitable if each evaluation has to be done at substantially identical boundary conditions as has been explained above.

It will be appreciated that the evaluation cycle may be gone through as a function of temporal events, i.e. at regular pre-defined intervals, and/or as a function of non-temporal events, e.g. as a function of an input of an operator of the target unit or as a function of other triggering events. For example, detection of a malfunction and/or abnormal behavior of the target unit may trigger the evaluation cycle.

It will be appreciated that execution of one single evaluation cycle with one single differential feature establishment cycle may be sufficient to perform evaluation and classification of the structural state of the target unit. However, with preferred embodiments, a plurality of differential feature establishment cycles is gone through in a comparatively short period of time to increase accuracy of the evaluation result. Hence, preferably, a batch of differential feature establishment cycles is executed within an evaluation period, the batch of differential feature establishment cycles comprising a plurality of executions of the differential feature establishment cycle. Preferably, the evaluation period ranges from 0.1 s to 60 min, preferably from 0.5 s to 10 min, more preferably from 1 s to 1 min. By this means, proper evaluation of the current situation is achieved, in particular, levelling out momentary errors. It will be appreciated however that, in particular depending on the target unit of interest and/or the type of damage or wear to be evaluated, shorter or longer evaluation periods may also be used.

Basically, any desired and suitable number of differential feature establishment cycles may be gone through. Preferably, the plurality of executions of the differential feature establishment cycle comprises 2 to 1000 executions, preferably 3 to 100 executions, more preferably 10 to 50 executions.

Furthermore, a further batch of differential feature establishment cycles is executed after a batch delay, the batch delay, in particular, ranging from 1 h to 30 days, preferably from 2 h to 7 days, more preferably from 12 h to 36 h. It will be appreciated however that, in particular depending on the target unit of interest and/or the type of damage or wear to be evaluated, shorter or longer batch delays may also be used.

It will be further appreciated that, the evaluation preferably is a permanent evaluation with regular repetition of evaluation cycles (e.g. continuous repetition or repetition at given intervals), typically over the entire lifetime of the target unit. The batch delays, as mentioned, may range from every few seconds to once per month or even once per year etc., typically depending on the specific focus of damage and/or wear determination or monitoring.

It will be appreciated that for any of the batches as outlined above, generally known averaging routines and/or error detection routines and/or data hygiene routines may be applied in order to achieve proper evaluation of the current situation.

Hence, preferably, the structural state in the evaluation step is determined as a function of an evaluation result of at least one previous differential feature establishment cycle of the batch of differential feature establishment cycles. Furthermore, preferably, each execution of the differential feature establishment cycle, occurs at substantially identical values of at least one first boundary condition parameter and/or at different values of at least one second boundary condition parameter

Preferably, the first boundary condition parameter is at least one temperature of the target unit and/or a temperature distribution of the target unit, while the second boundary condition parameter is at least one mechanical load, in particular, a mechanical load distribution, acting on the target unit and/or a mechanical stress, in particular, a mechanical stress distribution, present in the target unit and/or a mechanical strain, in particular, a mechanical strain distribution, present in the target unit, and/or a position and/or an orientation of at least one component of the target unit.

It will be appreciated that, with certain embodiments, the target unit is a wheel unit of a rail vehicle comprising a wheel unit shaft, at least one mechanical wave generator unit for generating the actual mechanical input signal and/or at least one mechanical wave detector unit for capturing the actual mechanical response signal is mechanically connected to the wheel unit shaft, in particular, at an end section of the wheel unit shaft, a batch of differential feature establishment cycles is executed within an evaluation period, the batch of differential feature establishment cycles comprising a plurality of executions of the differential feature establishment cycle, at least two executions of the differential feature establishment cycle, preferably each execution of the differential feature establishment cycle, occurring at different rotation angles of the wheel unit about an axis of rotation defined by the wheel unit shaft, the different rotation angles varying by 1° to 180°, preferably by 20° to 120°, more preferably by 45° to 90°. It will be appreciated however that, with certain embodiments, the evaluation may be executed continuously, i.e. without any specific given increments of the rotation angle. In any case, apparently, there is preferably provided a detector or the like providing corresponding information on the rotation angle (and, hence, the load situation) of the actual differential feature establishment cycle

The present invention further relates to a system for determining a structural state of at least one component of a mechanically loaded target unit, in particular a target unit of a rail vehicle, comprising at least one mechanical wave generator unit, at least one mechanical wave detector unit, and a control unit. The at least one mechanical wave generator unit is mechanically connected to the target unit and configured to introduce, in an actual excitation step of an evaluation cycle, a defined actual mechanical input signal into the target unit. The at least one mechanical wave detector unit is mechanically connected to the target unit and configured to capture, in an actual capturing step of the evaluation cycle, an actual mechanical response signal of the target unit to the mechanical input signal. The control unit is at least temporarily connectable to the at least one mechanical wave generator unit and the at least one mechanical wave detector unit. The control unit is further configured to compare, in an actual evaluation step of the evaluation cycle, the actual mechanical response signal to a previously recorded baseline signal to establish an actual differential feature and to use the actual differential feature to determine the structural state. The baseline signal is representative of a previous mechanical response signal of the target unit to a previous mechanical input signal, the previous mechanical input signal having a defined relation to the actual mechanical input signal. The control unit is configured to compare, in an actual differential feature comparison step of the actual evaluation step, the actual differential feature to at least one reference to determine the structural state, wherein the at least one reference is established from at least one previous differential feature, the at least one previous differential feature having been previously established for the target unit in a previous execution of the evaluation cycle. With this system the advantages and variants of the method according to the invention may be achieved to the same extent, such that reference is made insofar to the statements made above.

The present invention further relates to a vehicle, in particular, a rail vehicle, comprising a system according to the invention.

Further preferred embodiments of the invention become apparent from the dependent claims or the following description of preferred embodiments, which refers to the attached drawings.

### BRIEF DESCRIPTION OF THE DRAWINGS

FIG. 1 is a schematic sectional view of a preferred embodiment of a vehicle according to the invention with a preferred embodiment of a target unit according to the invention;

FIG. 2 is a schematic sectional view of a running gear of the vehicle from FIG. 1;

FIG. 3 is a block diagram of a preferred embodiment of a method for determining a structural state of at least one component of the target unit of the rail vehicle from FIG. 1.

FIG. 4 is a diagram showing a potential course of the ratio between the actual differential feature DFA and the expected reference differential feature RE for the target unit of the rail vehicle from FIG. 1.

FIG. 5 is a diagram showing a further potential course of the ratio between the actual differential feature DFA and the expected reference differential feature RE for the target unit of the rail vehicle from FIG. 1.

### DETAILED DESCRIPTION OF THE INVENTION

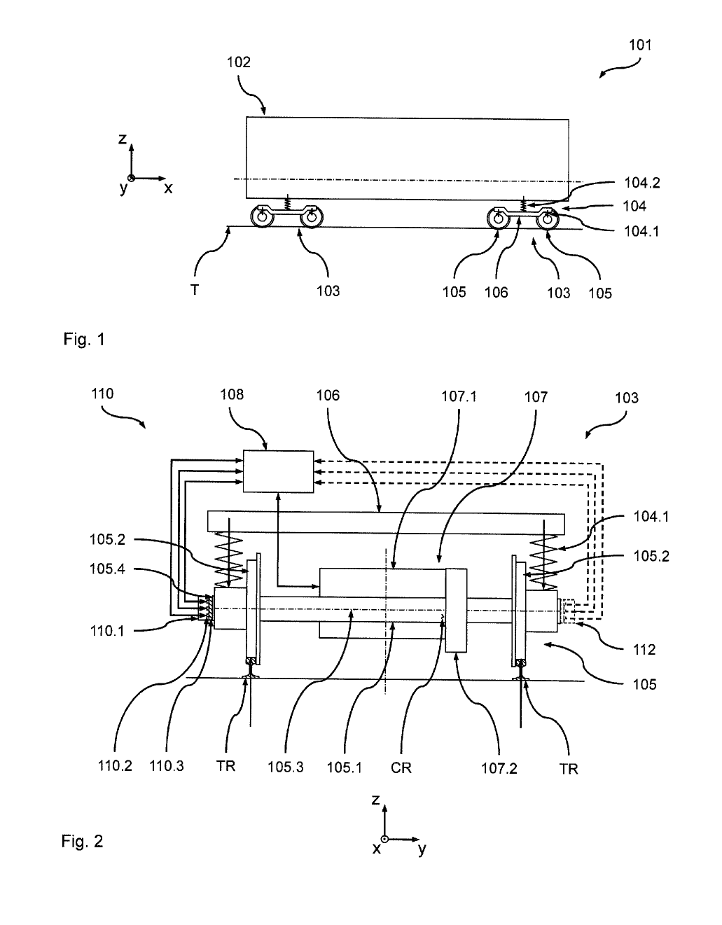

In the following, with reference to FIGS. 1 to 5, a preferred embodiment of a method for determining a structural state of at least one component of a mechanically loaded target unit of a rail vehicle 101 according to the invention will be described. The vehicle 101 may be a vehicle of a train set and, hence, may be coupled to one or more further vehicles (not shown) of the train set. Moreover, all or some of the vehicles of the train set may implement the present invention as described herein.

FIG. 1 shows a schematic sectional side view of the vehicle 101. The vehicle 101 comprises a wagon body 102, which in the area of its first end is supported on a running gear in the form of a first bogie 103 by means of a first spring device 104. In the area of its second end, the wagon body 102 is supported by means of a second spring device 104 on a second running gear in the form of a second bogie 103. The bogies 103 are of identical design. Similar applies to the spring devices 104. It is self-evident, however, that the present invention can also be used with other configurations in which other running gear designs are employed.

For ease of understanding of the explanations that follow, in the figures a coordinate system x, y, z (determined by the wheel contact plane of the bogies 104) is indicated, in which the x coordinate denotes the longitudinal direction of the rail vehicle 101, they coordinate denotes the transverse direction of the rail vehicle 101 and the z coordinate denotes the height direction of the rail vehicle 101.

The bogie 104 comprises two wheel units in the form of wheelsets 105, each of which supports a bogie frame 106 via the primary suspension 104.1 of the spring device 104. The wagon body 102 is supported via a secondary suspension 104.2 on the bogie frame 106. The primary suspension 104.1 and the secondary suspension 104.2 are shown in simplified form in FIG. 1 as helical springs. It is self-evident, however, that the primary suspension 104.1 or the secondary suspension 104.2 can be any suitable spring device. In particular, the secondary suspension 104.2 preferably is a sufficiently well-known pneumatic suspension or similar.

The bogie 104 is configured as a traction unit with its wheel sets 105 connected to a drive unit 107 driving the wheel set 105 and a controller unit 108 controlling the drive unit 107. The drive unit 107 comprises a motor 107.1 connected to a gear unit in the form of a gearbox 107.2, which transmits the motor torque MT in a conventional manner to the wheel set shaft 105.1 of the wheel set 105. The wheels 105.2 of the wheel set 105 are mounted to the wheel set shaft 105.1 in a press fit connection, such that the traction torque MT is transmitted to the rails TR of the track T resulting in a traction force FT at the wheel to rail contact point.

The wheel set shaft 105.1, obviously, is a mechanically highly loaded, safety relevant unit of the vehicle 101, which has to be monitored for its structural stability from time to time to ensure that it fulfils its function properly. Hence, the actual structural state of the wheel set shaft 105.1 as a target unit in the sense of the present invention is determined from time to time using a preferred embodiment of a method for determining a structural state of a mechanically loaded target unit according to the present invention as will now be described in greater detail.

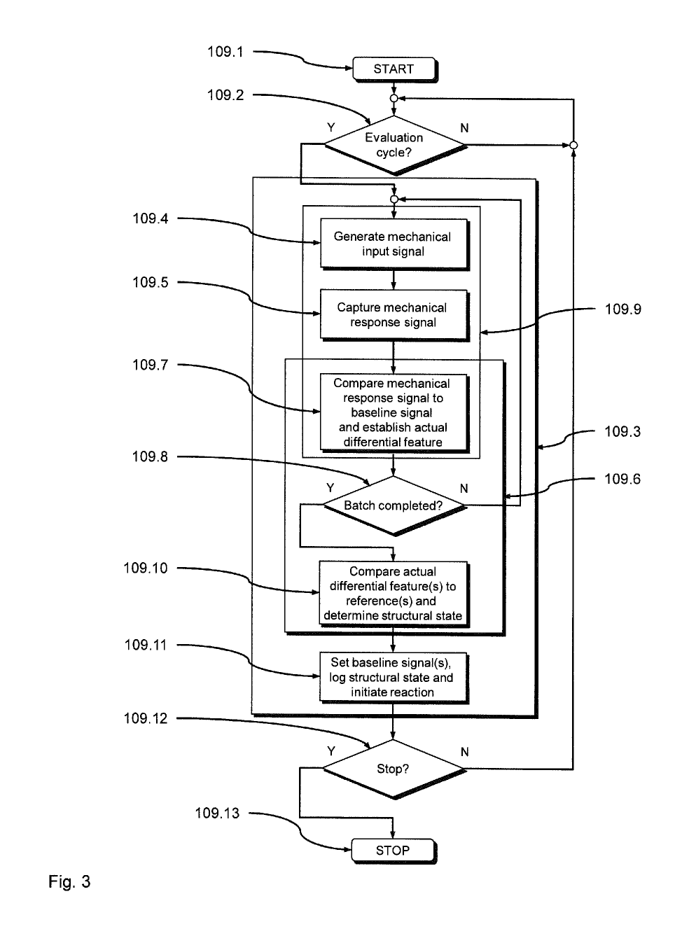

As can be seen from FIG. 3, the method starts in a step 109.1. Subsequently, in a step 109.2, it is checked if an evaluation cycle is to be initiated, wherein the actual structural state of the wheel set shaft 105.1 is determined.

If this is the case, a mechanical input signal is generated in a step 109.4 by a preferred embodiment of a system 110 for determining the structural state of the wheel set shaft 105.1 according to the invention. To this end, the system 110 comprises the control unit 108 and an evaluation box 110.1 mounted to a free axial end surface 105.4 of the wheel set shaft 105.1.

As can be seen from FIG. 2, the evaluation box 110.1 comprises an array of a plurality of N piezoelectric elements 110.2 firmly connected to a carrier plate 110.3. Each of the piezoelectric elements 110.2 is connected to the control unit 108 and configured to act, both, as a mechanical wave generator unit and as a mechanical wave detector unit under the control of the control unit 108.

To this end, each piezoelectric element 110.2 is controlled by the control unit 108 to introduce, in an actual excitation step 109.4 of an evaluation cycle 109.3, a defined actual partial mechanical input signal ISA1 to ISAN into the wheel set shaft 105.1. The partial mechanical input signals ISA1 to ISAN together form an actual mechanical input signal ISA, which is introduced into the wheel set shaft 105.1.

It will be appreciated that, basically, any mechanical input signal ISA may be used that is suitable for sufficiently long travel in the wheel set 105. In the present example, the actual mechanical input signal ISA is an ultrasound signal in a frequency range from 20 kHz to 20 MHz, preferably from 50 kHz to 1 MHz, more preferably from 80 kHz to 300 kHz. Another useful range is from 10 MHz to 20 MHz. Preferably, for larger size components (such as e.g. a wheel set shaft 105.1 of the wheel set 105) a frequency range of the mechanical input signal is between 80 kHz to 160 kHz, while for smaller size components (such as e.g. the gear(s) of gearbox 107.2) a frequency range of the mechanical input signal preferably is between 160 kHz to 240 kHz.

The control unit 108 may be configured to introduce the actual mechanical input signal ISA as one single mechanical input signal of arbitrary suitable duration. With particularly efficient variants, the control unit 108 is be configured to introduce the actual mechanical input signal ISA as an input signal, in particular, an input burst signal, having a duration of up to 1 s, preferably up to 0.75 s, more preferably up to 0.5 s, in particular, 0.1 s to 0.5 s. Such comparatively short signals or signal bursts allow simple evaluation largely avoiding problems with echo overlay.

The control unit 108 is configured to introduce the actual mechanical input signal ISA at a defined angle of rotation of the wheel set 105 about its wheel set axis 105.3. This angle of rotation is either captured by suitable sensors or adjusted by an operator of the vehicle 101 performing the current evaluation cycle 109.3.

Each of the piezoelectric elements 110.2, again under the control of the control unit 108, also acts as a mechanical wave detector unit by capturing, in an actual capturing step 109.5 of the evaluation cycle 109.3, an actual partial mechanical response signal RSA1 to RSAN, respectively, of the wheel set shaft 105.1 to the mechanical input signal ISA. The partial mechanical response signals RSA1 to RSAN together form an actual mechanical response signal RS, which is captured from the wheel set shaft 105.1 in response to the actual mechanical input signal ISA and forwarded to the control unit 108.

In the present example, the array comprises N=5 piezoelectric elements 110.2 mounted to the carrier plate 110.3, four of which are evenly distributed (on a circle with a defined radius) at the circumference of the carrier plate 110.3 in the vicinity of the outer circumference of the end surface 105.4, while one is located centrally in the area of the axis of rotation 105.3 of the wheel set shaft 105.1. Hence, along the circumferential direction of the wheel set shaft 105.1, the four outer piezoelectric elements 110.2 are shifted by an angle of 90°. It will be appreciated, however, that with other embodiments of the invention, any other desired number N and/or arrangement of the piezoelectric elements 110.2 may be selected. In particular, an uneven arrangement of the piezoelectric elements 110.2 may be selected, in particular, as a function of the mechanical response signal to be expected. In particular, one single piezoelectric element 110.2 may be sufficient in certain cases.

In order to provide proper introduction of the mechanical input signal IS into the wheel set shaft 105.1, the carrier plate 110.3 itself is releasably but firmly connected to the free end surface 105.4 of the wheel set shaft 105.1. This configuration also has the advantage that the evaluation box 110.1 does not necessarily have to be permanently fixed to the wheel set 105. It will be appreciated however that, with other embodiments of the invention, the evaluation box 110.1 may be permanently fixed to the wheel set shaft 105.1.

In the present example, the connection between the respective piezoelectric element 110.2 and the control unit 108 is a wireless connection provided by a suitable communication unit within the evaluation box 110.1 and the control unit 108, respectively. It will be appreciated however that, with other embodiments of the invention, any other type of (at least partially wireless and/or at least partially wired) connection may be selected. In particular, it may be provided that the evaluation box 110.1 collects the data representing the mechanical response signal RSA, which are then read out and transmitted to the control unit 108 only intermittently (i.e. from time to time).

It will be further appreciated that, in the present example, the piezoelectric elements 110.2 are configured to perform, in an initial self-testing step of step 109.4 and under the control of the control unit 108, one or more self-testing routines to assess their proper function and to exclude artefacts caused by malfunctions of one or more of the piezoelectric elements 110.2.

It will be appreciated that, in a variant of this embodiment, the partial mechanical input signals ISA1 to ISAN are generated in a given sufficiently rapid sequence to cause the partial mechanical response signals RSA1 to RSAN to form immediately consecutive instantaneous mechanical response signals as it has been described above.

More precisely, in this example, one of the piezoelectric elements 110.2 acts as a first mechanical wave generator and detector unit generating a first instantaneous mechanical input signal ISA1, while another one of the piezoelectric elements 110.2 forms a second mechanical wave generator and detector unit capturing the first instantaneous mechanical response signal RSA1 (resulting from the first instantaneous mechanical input signal ISA1 of the first generator and detector unit).

Then, after a response fading delay RFD (which preferably is as short as possible but ensures that the first instantaneous mechanical response signal RSA1 has sufficiently faded to avoid noticeable interference with the second instantaneous mechanical response signal RSA2), the signal path is inverted and the piezoelectric element 110.2 forming the second mechanical wave generator and detector unit generates a second instantaneous mechanical input signal ISA2, while the piezoelectric element 110.2 forming the first mechanical wave generator and detector unit now captures the second instantaneous mechanical response signal RSA2 (resulting from the second instantaneous mechanical input signal ISA2 of the piezoelectric element 110.2 forming the second generator and detector unit).

It will be appreciated that the response fading delay RFD may be any suitable delay, which is short enough to avoid noticeable variations in the boundary conditions but ensures that the first instantaneous mechanical response signal RSA1 has sufficiently faded to avoid noticeable interference with the second instantaneous mechanical response signal RSA2. Preferably, the response fading delay ranges from 0.01 s to 10 s, preferably from 0.1 s to 5 s, more preferably from 0.2 s to 2 s.

Similar applies to all further partial mechanical input signals up to ISAN and the partial mechanical response signals up to RSAN.

The immediately consecutive instantaneous mechanical response signals RSA1 to RSAN are then correlated in any suitable way, e.g. by cross correlation or even simple subtraction, to yield the actual mechanical response signal RSA, which is then used for establishing the differential feature as described herein.

In the present embodiment, a differential feature establishment step 109.7 of an evaluation step 109.6, the control unit 108 compares the actual mechanical response signal RSA to a baseline signal BS to establish an actual differential feature DFA representing the difference or deviation between the actual mechanical response signal RSA and the baseline signal BS.

The baseline signal BS is a previously recorded baseline signal that is representative of a previous mechanical response signal RSP of the wheel set shaft 105.1 to a previous mechanical input signal ISP, which has a defined relation to the actual mechanical input signal ISA. In the present example, the previous mechanical input signal ISP is substantially identical to the actual mechanical input signal ISA. It will be appreciated, however, that with other embodiments of the invention any other sufficiently well-known relation may be selected.

As mentioned above, the actual differential feature DFA is representative of a deviation between the actual mechanical response signal RSA and the baseline signal BS. Basically, any expression providing corresponding information may be used. Preferably, the differential feature DFA is a normalized squared error between the actual mechanical response signal RSA and the baseline signal BS and/or a drop in a correlation coefficient between the actual mechanical response signal RSA and the baseline signal BS and/or a drop in a correlation coefficient between the actual mechanical response signal RSA and the baseline signal BS and/or a feature obtained from Principal Component Analysis (PCA), in particular, Nonlinear Principal Component Analysis (NLPCA), in particular Hierarchical Nonlinear Principal Component Analysis (h-NLPCA), and/or a feature obtained from Independent Component Analysis (ICA). Some of these options has been described in Michaels (as mentioned initially) and provide, in a fairly simple manner, proper information on the deviation between the actual mechanical response signal RSA and the baseline signal BS.

With further embodiments the differential feature DFA may be a feature obtained from at least one of the following methods or approaches, namely difference formation in the time domain, phased adjusted difference formation in the time domain, difference formation in the frequency domain, cross-correlation, signal time-of-flight analysis, regression analysis, Kalman filter analysis, pattern recognition analysis, self-organizing maps (SOM), support vector machines (SVM), neuronal networks, multi-variant methods, such as cluster analysis, multi-dimensional scaling (MDS) and null-subspace analysis.

It will be appreciated that, in determining the differential feature DFA may be obtained using digital filtering, in particular, using Bessel filters and/or Butterworth filters and/or Tschebyscheff filters, and/or using analog processing, in particular, analog filtering, prior to A/D conversion and further processing.

In the present example, in a step 109.8, it is then checked if a batch with a sequence of differential feature establishment cycles 109.9 is to be executed and, if yes, if the batch sequence is already completed. If the latter is not the case, the method jumps back to step 109.4 and generates a further actual mechanical input signal ISA in a further execution of the differential feature establishment cycle 109.9.

It will be appreciated that, in the present embodiment, the differential feature establishment cycles 109.9 are executed at well-defined boundary conditions, such that consideration of these boundary conditions is greatly simplified. Preferably, the differential feature establishment cycles are executed at a defined daytime, e.g. prior to normal operation of the rail vehicle 101 after a certain rest period (e.g. overnight rest in a vehicle depot), such that for certain boundary conditions approximately stable and constant values are given. In the present example, in particular, an approximately stable and even temperature distribution throughout the wheel set shaft 105.1 is given as a first boundary condition parameter.

However, in the present example, it is desired to have a defined modification of another, second boundary condition over the batch of differential feature establishment cycles 109.9, as will be explained in the following. If, for example, a circumferentially oriented crack 111 in the outer circumference of the wheel set shaft 105.1 is present, such a crack 111, typically, behaves differently under the load of the vehicle 101 as a function of the rotation angle of the shaft 105.1.

If the crack 111 is located in the tensile stress zone of the shaft 105.1 (i.e. if the crack 111 is facing upwards in the embodiment shown in FIG. 2), it will open up, thereby forming an obstacle providing pronounced scattering of the mechanical waves introduced as the actual mechanical input signal ISA by the piezoelectric elements 110.2. This scattering is then clearly visible in the captured mechanical response signal RSA.

On the other hand, if the crack 111 is located in the compressive stress zone of the shaft 105.1 (i.e. if the crack 111 is facing downwards towards the track T), it will close with its surfaces being firmly pressed against each other. In these cases, the crack 111 will not form an obstacle providing noticeable scattering of the mechanical waves of the piezoelectric elements 110.2. Hence, a corresponding scattering pattern will not be visible in the actual mechanical response signal RSA.

Hence, in the present case, the evaluation will be done on the basis of the results of a batch of four differential feature establishment cycles 109.9 (performed within a sufficiently short period of time) at defined different angles of rotation of the shaft 105.1 about its axis of rotation 105.3 to account for this fact. More precisely, the angle of rotation (forming a second boundary condition parameter in the sense of the present invention), will be modified by 90° for each of the four cycles 109.9 of the batch.

It will be appreciated, however, that with other embodiments of the invention, any other desired number of cycles 109.9 with a different angular resolution of the angle of rotation may be selected. In particular, with certain embodiments of the invention, eventually even one single cycle 109.9 may be sufficient.

It will be appreciated that the differential feature establishment cycles 109.9 of the batch are executed within a suitably short evaluation period, which among others ensures that substantially no structural modifications occur to the wheel set 105 during the batch. Preferably, the evaluation period ranges from 0.1 s to 60 min, preferably from 0.5 s to 10 min, more preferably from 1 s to 1 min. By this means, proper evaluation of the current situation is achieved.

It will be further appreciated that, with other embodiments of the invention, any desired and suitable other number of differential feature establishment cycles 109.9 may be gone through. Preferably, the plurality of executions of the differential feature establishment cycle 109.9 comprises 2 to 1000 executions, preferably 3 to 100 executions, more preferably 10 to 50 executions.

It will be appreciated that the respective actual differential feature DFA is stored in the control unit 108 in a manner specifically assigned to its specific differential feature establishment cycle 109.9, i.e. its position within the batch sequence. Hence, for every differential feature establishment cycle 109.9 within the batch sequence there is a specific differential feature DFA stored in the control unit 108.

In an actual differential feature comparison step 109.10 of the actual evaluation step 109.3, the respective actual differential feature DFA of the respective cycle 109.9 is compared to a reference R to determine the structural state of the wheel set shaft 105.1. The respective reference R is established from a plurality of previous differential features DFP, the previous differential features DFP having been previously established for the wheel set 105.1 in a corresponding differential feature establishment cycle 109.9 of a previous execution of the evaluation cycle 109.3.

In the present example, the respective reference R for the respective cycle 109.9 is established from a plurality of previous differential features DFP, each of the plurality of previous differential features DFP having been previously established for the wheel set 105 in a plurality of previous executions of the evaluation cycle 109.3. Hence, a history of the differential feature DFP is considered, which allows simpler and more precise classification of the actual structural state of the wheel set shaft 105.1.

In the present example, each of the previous differential features DFP used in the actual evaluation cycle 109.3 has been established in a different previous execution of the evaluation cycle 109.3. More precisely, in the present embodiment, the previous differential features DFP have been established in a continuous series of previous executions of the evaluation cycle 109.3 immediately preceding the actual evaluation cycle 109.3.

Furthermore, in the present example, the respective reference R (assigned to the respective cycle 109.9) is established by extrapolation from the sequence of the assigned previous differential features DFP. By this means it is possible, for example, to establish, as the respective reference R, a reference differential feature RE that is expected, at the point in time of the establishment actual differential feature DFA, in view of the history of the previous differential features DFP. Hence, in other words, the respective reference R is an expected reference differential feature RE.

If, for example, the actual differential feature DFA noticeably deviates from the expected reference differential feature RE to an extent that goes beyond normal tolerances, damage is likely to have occurred in the wheel set shaft 105.1, that causes this abnormal deviation.

Hence, in the present example, in a classification step of step 109.10, the structural state of the wheel set shaft 105.1 is classified as a function of a result of the comparison between the respective actual differential feature DFA and the reference differential feature RE.

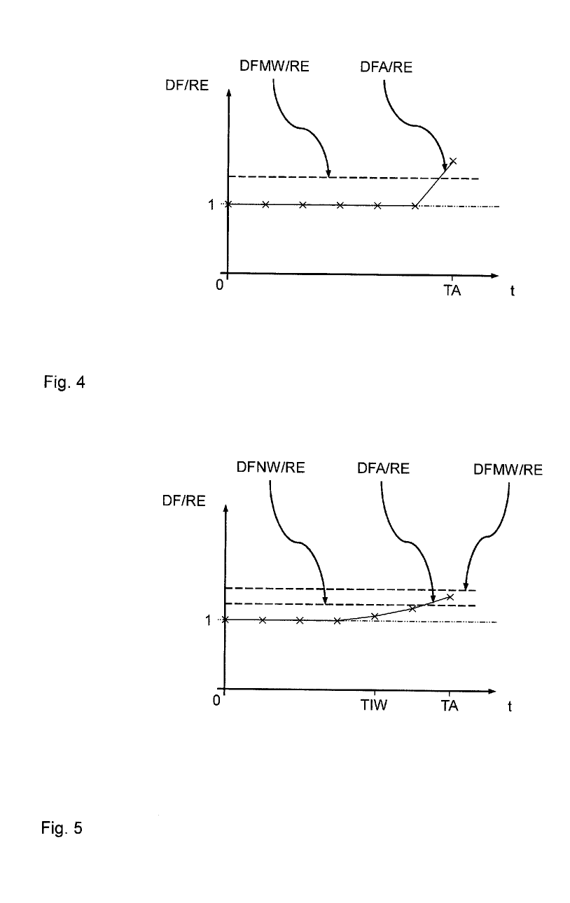

In the present example, the structural state of the wheel set shaft is classified as a damaged state if a deviation between one or more of the respective actual differential features DFA and the respective associated expected reference differential feature RE exceeds a damage threshold DT. The damage threshold DT is a maximum wear differential feature DFMW representative of a maximum wear to be expected at the point in time TA of the actual capturing step 109.5, as it is schematically shown in FIG. 4.

Furthermore, the structural state is classified as a damaged state if a speed of alteration of the course of the differential feature DF obtained with the actual differential feature DFA (and the previous differential features DFP) with respect to the reference R (i.e. the course of the differential feature DF to be expected from the extrapolation of the previous differential features DFP) exceeds a damage threshold speed DTS. Herein, the damage threshold speed DTS is a maximum speed of alteration to be expected at the point in time of the actual capturing step 109.5. Hence, in a simple manner, unexpected steps or jumps in the course of the respective differential feature DF are classified as a damage situation.

Furthermore, in the present example, the structural state of the wheel set shaft 105.1 is classified as an excessively worn state if a deviation between the actual differential feature and the expected reference differential feature RE exceeds a normal wear threshold NWT, the normal wear threshold being a normal wear differential feature DFNW representative of a normal wear to be expected at the point in time of the actual capturing step 109.5, as it is schematically shown in FIG. 5. In other words, if the deviation in the differential feature DFA exceeds a threshold NWT that is expected under normal wear conditions, it may be assumed that such an excessively worn situation is present. As may be seen from FIG. 5, such an excessively worn situation already is indicated by the steadily (from a point in time of increased wear TIW) increasing deviation between the actual differential feature DFA and the reference RE

Furthermore, in the present example, an excessively worn situation is presumed if the course of the differential feature DF obtained with the actual differential feature DFA (and the previous differential features DFP) increases faster than expected under normal wear conditions. Hence, preferably, the structural state is classified as an excessively worn state if a speed of alteration of at least one of the respective actual differential features DFA with respect to the reference exceeds a normal wear threshold speed NWTS, the normal wear threshold speed NWTS being a speed of alteration to be expected at the point in time of the actual capturing step 109.5 under normal wear conditions.

It will be appreciated that, with certain embodiments with sufficiently stable boundary conditions, the respective actual differential feature DFA may simply be taken as it is determined in the differential feature establishment step 109.7. In the present example, however, a deviation in the temperature as a highly relevant boundary condition between the respective actual cycle 109.9 and relevant previous cycles 109.9 on the previous evaluation cycles 109.3 (considered in the actual step 109.10) is taken into account.

Hence, in the present example, in an boundary condition assessment step of step 109.7, i.e. prior to the actual differential feature comparison step 109.10, an actual value of the temperature distribution within the wheel set 105 is determined, and in a correction step prior to the actual differential feature comparison step 109.10, the actual mechanical response signal RSA is corrected as a function of a difference in the actual value of the temperature distribution and a recorded value of the temperature distribution determined at the point in time of the respective previous execution of the evaluation cycle 109.3, more precisely, at the point in time of the capturing step 109.5 of the respective previous execution of the evaluation cycle 109.3.

By this means it is ensured that all the differential features of the previous executions of the evaluation cycles 109.3 as well as the actual evaluation cycle 109.3 are based on the same temperature situation within the wheel set 105.

In the present example, a model based approach is used to provide in a simple manner a suitably fine resolution of the temperature distribution. In the present example, the temperature distribution is established in the control unit 108 using one or more measurement values of the temperature (captured at one or more locations of the wheel set 105) as temperature input values and a temperature model of wheel set 105 (stored in the control unit 108). The temperature model provides a temperature distribution over the wheel set 105 as a function of these temperature input values.

In the present example, further refined classification is done as will be explained in the following. First of all, damage and wear classification is done on the basis of a common consideration of the results of the actual differential feature comparison step 109.10 for all actual differential features DFA of the four differential feature establishment steps 109.9. In doing so, a plausibility check is performed ensuring that proper classification is obtained.

Moreover, in a damage localization step of the actual evaluation step 109.6, in case of a classification of the structural state as a damaged state, a damage localization step is executed using the respective actual mechanical response signal RSA. Similarly, in an excessive wear localization step of the actual evaluation step 109.6, in case of a classification of the structural state as an excessively worn state, an excessive wear localization step is executed using the respective actual mechanical response signal RSA.

It will be appreciated that any desired and suitable localization method may be executed. In particular, any of the methods generally described in Michaels and Torres-Arredondo et al. (as mentioned initially) may be executed (alone or in arbitrary combination).

With other preferred embodiments, the localization step of the actual evaluation step 109.6 is executed using a difference between the actual mechanical response signal RSA and at least one previous mechanical response signal RSP of the shaft 105.1, wherein the at least one previous mechanical response signal RSP has been established using a different, in particular inverted, signal path through the shaft 105.1. By this means particularly simple localization may be achieved.

As an alternative, the localization step of the actual evaluation step 109.6 may be executed using a difference between the actual differential feature and at least one previous differential feature established for the target unit, the at least one previous differential feature having been established using a different, in particular inverted, signal path through the target unit. By any of these means particularly simple localization may be achieved.

In addition or as an alternative, the localization step may be executed by comparing the actual mechanical response signal RSA and at least one modeled mechanical response signal, the at least one modeled mechanical response signal having been established using a model of the target unit. By this means simple localization may be achieved by identifying one or more deviations from an expected (modeled) situation which are characteristic for specific damage and/or wear at specific locations.

Furthermore, in the present example, the localization step may be executed using a damage pattern recognition algorithm, the damage pattern recognition algorithm comparing the actual mechanical response signal RSA to a plurality of damage patterns DPP previously established for the wheel set shaft 105.1, each of the damage patterns DPP representing a damage mechanical response signal DRS to be captured in response to the mechanical input signal upon a specific damage introduced at a specific location in the wheel set shaft 105.1. A similar approach may be taken for wear localization. By this means a very simple and reliable localization may be achieved.

In the present example, in each execution of the evaluation cycle 109.3, a floating baseline signal BS is used, i.e. a baseline signal BS that is modified over time. Such a floating baseline signal BS, among others, has the advantage that low speed modifications in the evaluation system, such as drift effects, become less critical. Hence, in the present example, in a baseline setting step of a step 109.11 after the actual evaluation step 109.10, the respective actual mechanical response signal RSA is set as the baseline signal BS (in a memory of control unit 108) to be used in a subsequent evaluation cycle 109.3 to form the respective floating baseline signal BS.

Furthermore, in a logging step after the classification step of step 109.10, the respective actual differential feature DFA, the respective reference R and the classification established in the classification step is stored for use in later data analysis and for use in the determination of a subsequent reference R, in particular, for extrapolation of the respective expected reference differential feature RE as it has been described above.

Furthermore, in the present example, the result of the classification of step 109.10 triggers a suitable reaction in a reaction step of step 109.11. The reaction is triggered as a function of the outcome of the classification. The reaction may be of any suitable type, e.g. an automatic alarm notification to a driver or an operator of the vehicle 101. This is particularly the case, if potentially hazardous damage is detected. Furthermore, maintenance need notifications or the like may be transmitted to an operator of the vehicle 101 or other institutions responsible therefore.

Furthermore, due the safety level of the wheel set shaft 105.1, the reaction may immediately influence operation of the wheel set shaft 105.1 and, ultimately, operation of the vehicle 101. For example, automatic emergency braking of the vehicle 101 may be initiated in case of potentially hazardous and critical damage situations.

In a step 109.12 is then checked if the course of the method is to be terminated. If this is the case, the course of the method is stopped in a step 109.13. Otherwise, the method jumps back to step 109.2. It will be appreciated that the check performed in step 109.2 may be done as a function of arbitrary conditions. Typically, a new execution of the evaluation cycle 110.3 is initiated after a certain amount of time has elapsed since the last execution of the evaluation cycle 110.3. Preferably, a further evaluation cycle 110.3 with a further batch of differential feature establishment cycles 109.9 is executed after a certain batch delay. Typically, the batch delay ranges from 1 h to 30 days, preferably from 2 h to 7 days, more preferably from 12 h to 36 h.

It will be appreciated, however, that any other non-temporal events may also be used to trigger execution of a further evaluation cycle 110.3. In particular, a corresponding input of an operator of the vehicle 101 may initiate a further evaluation cycle 110.3

It will be appreciated that the mechanical wave generator unit and the mechanical wave detector unit, with other embodiments of the invention, may be separate components or units, respectively. For example, the piezoelectric elements 110.2 of the evaluation box 110 may only form the mechanical wave generating units, while a separate evaluation box with a suitable number of piezoelectric elements forming the mechanical wave detector units is provided at a different location of the wheel set shaft 105.1 as it is indicated in FIG. 2 by the dashed contour 112. Apparently, a mix of both variants may also be implemented.

The present invention, in the foregoing, has only been described using an example of a railway vehicle 101 carrying the entire system 110. It will be appreciated, however, that the system 110 may also be a distributed system, where, for example, the functions implemented in the control unit 108 of vehicle 101 are implemented in a different unit (e.g. even in a remote data center) separate and, eventually, remote from the remaining parts of the system.

The present invention, in the foregoing, has only been described using an example of a wheel set shaft 105 of a railway vehicle 101. It will be appreciated that, as mentioned above, the invention may be used in any desired other environment within the railway vehicle 101.

Furthermore, any other type of mechanically loaded structure may be the target unit or target structure, respectively, according to the present invention. Particularly beneficial results may be achieved, for example, in any type of transportation means (vehicles, airplanes, ships etc.), in any type of building environment (buildings, infrastructure units etc.), any type of industrial environment (power plants, industrial machines etc.) and so on.

1. A method for determining a structural state of at least one component of a mechanically loaded target unit, in particular a target unit of a rail vehicle, said method comprising,
in an actual excitation step of an evaluation cycle, introducing a defined actual mechanical input signal into said target unit,
in an actual capturing step of said evaluation cycle, capturing an actual mechanical response signal of said target unit to said mechanical input signal, and,
in an actual evaluation step of said evaluation cycle, comparing said actual mechanical response signal to a previously recorded baseline signal to establish an actual differential feature and using said actual differential feature to determine said structural state;
wherein said baseline signal being representative of a previous mechanical response signal of said target unit to a previous mechanical input signal, said previous mechanical input signal having a defined relation to said actual mechanical input signal;
wherein in an actual differential feature comparison step of said actual evaluation step, comparing said actual differential feature to at least one reference to determine said structural state, and
wherein said at least one reference is established from at least one previous differential feature, said at least one previous differential feature having been previously established for said target unit in a previous execution of said evaluation cycle.

2. The method according to claim 1, wherein,
in a baseline setting step after said actual evaluation step, said actual mechanical response signal is set as said baseline signal to be used in a subsequent evaluation step to form a floating baseline signal, and,
said actual differential feature and said previous differential feature are established using a fixed baseline signal.

3. The method according to claim 1, wherein,
said at least one reference is formed from a plurality of previous differential features including said previous differential feature, each of said plurality of previous differential features having been previously established for said target unit in a plurality of previous executions of said evaluation cycle,
wherein, in particular,
said previous differential feature has been established in an immediately preceding previous execution of said evaluation cycle;
each of said plurality of previous differential features has been established in a different previous execution of said evaluation cycle;
each of said plurality of previous differential features has been established in a continuous series of previous executions of said evaluation cycle;
said at least one reference is established by extrapolation from said plurality of previous differential features,
said previous differential feature has been established using at least one comparison target unit under comparison boundary conditions having a defined relation to boundary conditions under which said actual differential feature is established;
said at least one reference is an expected reference differential feature established, in particular, by extrapolation, from said plurality of previous differential features;
or
said actual mechanical response signal and said previous mechanical response signal have been captured along different signal paths.

4. The method according to any one of claim 1, wherein,
in a classification step of said actual evaluation step, said structural state is classified as a function of a result of said comparison between said actual differential feature and said at least one reference,
wherein, in particular,
in a logging step after said classification step, at least said actual differential feature and/or said at least one reference and/or said classification established in said classification step is stored;
in a reaction step after said classification step, a reaction is initiated as a function of said classification established in said classification step, said reaction, in particular, comprising a notification of said classification and/or a modification of an operational state of said target unit;
said structural state is classified as a damaged state if a deviation between said actual differential feature and said at least one reference exceeds a damage threshold, said damage threshold being a maximum wear differential feature representative of a maximum wear to be expected at the point in time of said actual capturing step,
said structural state is classified as a damaged state if a speed of alteration of said actual differential feature with respect to said at least one reference exceeds a damage threshold speed, said damage threshold speed being a maximum speed of alteration to be expected at the point in time of said actual capturing step,
said structural state is classified as an excessively worn state if a deviation between said actual differential feature and said at least one reference exceeds a normal wear threshold, said normal wear threshold being a normal wear differential feature representative of a normal wear to be expected at the point in time of said actual capturing step,
or
said structural state is classified as an excessively worn state if a speed of alteration of said actual differential feature with respect to said at least one reference exceeds a normal wear threshold speed, said normal wear threshold speed being a speed of alteration to be expected at the point in time of said actual capturing step under normal wear conditions.

5. The method according to claim 1, wherein,
in a boundary condition assessment step, an actual value of at least one boundary condition parameter influencing said actual mechanical response signal is determined, and
in a correction step prior to said actual differential feature comparison step, said actual mechanical response signal is corrected as a function of a difference in said actual value of said at least one boundary condition parameter and a recorded value of said at least one boundary condition parameter determined at the point in time of said previous execution of said evaluation cycle, in particular, at the point in time of said excitation step and/or said capturing step of said previous execution of said evaluation cycle,
wherein, in particular,
said boundary condition parameter is at least one temperature of said target unit and/or of an atmosphere surrounding said target unit and/or a temperature distribution of said target unit and/or of an atmosphere surrounding said target unit and/or at least one mechanical load, in particular, a mechanical load distribution, acting on said target unit and/or a mechanical stress, in particular, a mechanical stress distribution, present in said target unit and/or a mechanical strain, in particular, a mechanical strain distribution, present in said target unit, and/or a vibration frequency spectrum of said target unit, and/or a position and/or an orientation of at least one component of said target unit and/or a humidity of said target unit and/or a humidity of an atmosphere surrounding said target unit and/or a viscosity of an atmosphere surrounding said target unit and/or a density of an atmosphere surrounding said target unit, and/or a flow rate of an atmosphere surrounding said target unit, said atmosphere, in particular being a liquid atmosphere and/or a gas atmosphere;
said boundary condition parameter is established using at least one input value representative of said boundary condition parameter and a model of said target unit, said model providing a distribution of said boundary condition parameter over at least a part of said target unit as a function of said at least one input value, said model, in particular, being a temperature model of said target unit providing a temperature distribution over at least a part of said target unit as a function of said at least one input value, said at least one input value, in particular, being at least one temperature value captured at said target unit or in a vicinity of said target unit or
said actual differential feature has been established at a first value of said at least one boundary condition parameter and said at least one reference has been established at a second value of said at least one boundary condition parameter, and, in a classification step of said actual evaluation step, said structural state is classified as a function of a difference between said first value of said at least one boundary condition parameter and said second value of said at least one boundary condition parameter.

6. The method according to claim 1, wherein,
in a damage localization step of said actual evaluation step, in case of a classification of said structural state as a damaged state, a damage localization step is executed using at least said actual mechanical response signal;
and
in an excessive wear localization step of said actual evaluation step, in case of a classification of said structural state as an excessively worn state, an excessive wear localization step is executed using at least said actual mechanical response signal,
wherein, in particular,
said localization step is executed using a difference between said actual mechanical response signal and at least one previous mechanical response signal of said target unit, said at least one previous mechanical response signal having been established using a different, in particular inverted, signal path through said target unit;
said localization step is executed using a difference between said actual differential feature and at least one previous differential feature established for said target unit, said at least one previous differential feature having been established using a different, in particular inverted, signal path through said target unit;
said localization step is executed by comparing said actual mechanical response signal and at least one modeled mechanical response signal, said at least one modeled mechanical response signal having been established using a model of said target unit;
or
said localization step is executed using damage pattern recognition algorithm, said damage pattern recognition algorithm comparing said actual mechanical response signal to a plurality of damage patterns previously established for said target unit, each of said damage patterns representing a damage mechanical response signal to be captured in response to said mechanical input signal upon a specific damage introduced at a specific location in said target unit.

7. The method according to claim 1, wherein
said at least one previous differential feature has been previously established using an initial baseline signal, said initial baseline signal being a mechanical response signal of said target unit to said previous mechanical input signal in a new and undamaged state;
said differential feature is representative of a deviation between said actual mechanical response signal and said baseline signal
said differential feature is a normalized squared error between said actual mechanical response signal and said baseline signal and/or a drop in a correlation coefficient between said actual mechanical response signal and said baseline signal and/or a drop in a correlation coefficient between said actual mechanical response signal and said baseline signal and/or a feature obtained from Principal Component Analysis, in particular, Nonlinear Principal Component Analysis, in particular Hierarchical Nonlinear Principal Component Analysis, and/or a feature obtained from Independent Component Analysis;
said differential feature is a feature obtained from at least one of difference formation in the time domain, phased adjusted difference formation in the time domain, difference formation in the frequency domain, cross-correlation, signal time-of-flight analysis, regression analysis, Kalman filter analysis, pattern recognition analysis, self-organizing maps, support vector machines, neuronal networks, multi-variant methods, such as cluster analysis, multi-dimensional scaling and null-subspace analysis;
said differential feature is a feature obtained using digital filtering, in particular, using Bessel filters and/or Butterworth filters and/or Tschebyscheff filters, and/or using analog processing, in particular, analog filtering prior to A/D conversion;
or
said actual mechanical response signal is a correlated mechanical response signal generated by correlation, in particular, cross correlation or subtraction, from at least two immediately consecutive instantaneous mechanical response signals captured by at least one signal detector, preferably at least two different signal detectors.

8. The method according to claim 1, wherein
said actual mechanical input signal is an ultrasound signal and/or a signal in a frequency range from 20 kHz to 20 MHz, preferably from 50 kHz to 1 MHz or from 10 MHz to 20 MHz, more preferably from 80 kHz to 300 kHz,
said actual mechanical input signal comprises at least one input signal, in particular, an input burst signal, having a duration of up to 1 s, preferably up to 0.75 s, more preferably up to 0.5 s, in particular, 0.1 s to 0.5 s;
a frequency of said actual mechanical input signal is selected as a function of parameter of said target unit and/or a parameter of an atmosphere surrounding said target unit
said actual mechanical input signal comprises a plurality of partial input signals, each partial input signal being introduced into said target unit at a different location of said target unit,
said actual mechanical response signal is captured as an echo signal, in particular directly after introducing said actual mechanical input signal, at the location of introduction of said actual mechanical input signal into said target unit,
said actual mechanical response signal comprises a plurality of partial response signals, each partial response signal being captured, in particular substantially simultaneously, at a different location of said target unit,
at least one mechanical wave generator unit for generating said actual mechanical input signal and/or at least one mechanical wave detector unit for capturing said actual mechanical response signal is mechanically connected to said target unit;
at least one mechanical wave generator unit for generating said actual mechanical input signal and/or at least one mechanical wave detector unit for capturing said actual mechanical response signal is mechanically connected to said target unit, in particular, permanently or via a carrier unit releasably connected to said target unit;
an array of mechanical wave generator units for generating said actual mechanical input signal and/or an array of mechanical wave detector units for capturing said actual mechanical response signal is mechanically connected to said target unit, in particular, permanently or via a carrier unit releasably connected to said target unit;
at least one mechanical wave generator unit for generating said actual mechanical input signal and at least one mechanical wave detector unit for capturing said actual mechanical response signal is mechanically connected to said target unit, said at least one mechanical wave generator unit and said at least one mechanical wave detector unit, in a self-testing step, executing a self-test to assess their proper function;
or
at least one mechanical wave generator and detector unit for generating said actual mechanical input signal and for capturing said actual mechanical response signal is mechanically connected to said target unit,

9. The method according to claim 1, wherein
said target unit is a unit of a rail vehicle, said target unit, in particular, comprising a wheel unit, in particular, a wheel set, and/or wheel unit shaft and/or wheel unit axle and/or a drive unit and/or a drive motor unit and/or a drive gear unit and/or a wheel bearing unit and/or a running gear frame unit and/or a wagon body unit and/or a suspension unit and/or a current collector unit and/or a compressor unit and/or an electrical equipment unit, in particular a transformer unit and/or a converter unit;
said target unit is a wheel unit, in particular, a wheel set, of a rail vehicle and at least one mechanical wave generator and/or at least one mechanical wave detector unit is connected to an end section of a wheel unit shaft of said wheel unit;
said target unit is a unit of a motor vehicle, in particular, a structural unit of a power train and/or a running gear and/or a bodywork of said motor vehicle;
said target unit is a unit of an airplane, in particular, a structural unit of a power train and/or a running gear and/or a bodywork of said airplane;
said target unit is a unit of a ship, in particular, a structural unit of a power train and/or a bodywork of said ship;
said target unit is a unit of an industrial machine, in particular, a structural unit of a power train and/or a support structure of said industrial machine;
said target unit is a unit of a building, in particular, a structural unit of a support structure of said building;
said target unit is a unit of a tubing network, in particular, at least one tube of said tubing network;
said target unit is a unit of a storage tank or pressure tank, in particular, at least one wall of said tank;
said target unit is a unit of a wind energy plant, in particular, an electrical equipment unit of said wind energy plant and/or a structural unit of a pylon or a housing or a gear or a rotor component of said wind energy plant;
said target unit is a spacecraft, in particular, a structural unit of a bodywork of said spacecraft;
or
said target unit is a unit of a military tank, in particular, a structural unit of a power train or a running gear or a bodywork of said military tank.

10. The method according to claim 1, wherein
at least one execution of said evaluation cycle ensues during normal operation of said target unit;
at least one execution of said evaluation cycle ensues during downtime of said target unit;
a batch of differential feature establishment cycles is executed within an evaluation period, said batch of differential feature establishment cycles comprising a plurality of executions of said differential feature establishment cycle, said structural state in said evaluation step, in particular, being determined as a function of a result of at least one previous differential feature establishment cycle of said batch of differential feature establishment cycles, said evaluation period, in particular, ranging from 0.1 s to 60 min, preferably from 0.5 s to 10 min, more preferably from 1 s to 1 min, said plurality of executions of said differential feature establishment cycle, in particular, comprising 2 to 1000 executions, preferably 3 to 100 executions, more preferably 10 to 50 executions, a further batch of differential feature establishment cycles, in particular, being executed after a batch delay, said batch delay, in particular, ranging from 1 h to 30 days, preferably from 2 h to 7 days, more preferably from 12 h to 36 h,
a batch of differential feature establishment cycles is executed within an evaluation period, said batch of differential feature establishment cycles comprising a plurality of executions of said differential feature establishment cycle, at least two executions of said differential feature establishment cycle, preferably each execution of said differential feature establishment cycle, occurring at substantially identical values of at least one first boundary condition parameter and/or at different values of at least one second boundary condition parameter, said first boundary condition parameter, in particular, being at least one temperature of said target unit and/or a temperature distribution of said target unit, said second boundary condition parameter, in particular, being at least one mechanical load, in particular, a mechanical load distribution, acting on said target unit and/or a mechanical stress, in particular, a mechanical stress distribution, present in said target unit and/or a mechanical strain, in particular, a mechanical strain distribution, present in said target unit, and/or a position and/or an orientation of at least one component of said target unit;
said target unit is a wheel unit of a rail vehicle comprising a wheel unit shaft, at least one mechanical wave generator unit for generating said actual mechanical input signal and/or at least one mechanical wave detector unit for capturing said actual mechanical response signal is mechanically connected to said wheel unit shaft, in particular, at an end section of said wheel unit shaft, a batch of differential feature establishment cycles is executed within an evaluation period, said batch of differential feature establishment cycles comprising a plurality of executions of said differential feature establishment cycle, at least two executions of said differential feature establishment cycle, preferably each execution of said differential feature establishment cycle, occurring at different rotation angles of said wheel unit about an axis of rotation defined by said wheel unit shaft, said different rotation angles varying by 1° to 180° preferably by 20° to 120°, more preferably by 45° to 90°.

11. A system for determining a structural state of at least one component of a mechanically loaded target unit, in particular a target unit of a rail vehicle, comprising,
at least one mechanical wave generator unit,
at least one mechanical wave detector unit, and
a control unit;
said at least one mechanical wave generator unit being mechanically connected to said target unit and configured to introduce, in an actual excitation step of an evaluation cycle, a defined actual mechanical input signal into said target unit,
said at least one mechanical wave detector unit being mechanically connected to said target unit and configured to capture, in an actual capturing step of said evaluation cycle, an actual mechanical response signal of said target unit to said mechanical input signal, and,
said control unit being at least temporarily connectable to said at least one mechanical wave generator unit and said at least one mechanical wave detector unit and being configured to compare, in an actual evaluation step of said evaluation cycle, said actual mechanical response signal to a previously recorded baseline signal to establish an actual differential feature and to use said actual differential feature to determine said structural state;
said baseline signal being representative of a previous mechanical response signal of said target unit to a previous mechanical input signal, said previous mechanical input signal having a defined relation to said actual mechanical input signal;
characterized in that,
said control unit is configured to compare, in an actual differential feature comparison step of said actual evaluation step, said actual differential feature to at least one reference to determine said structural state, wherein
said at least one reference is established from at least one previous differential feature, said at least one previous differential feature having been previously established for said target unit in a previous execution of said evaluation cycle.

12. The system according to claim 11, wherein,
said control unit is configured to set, in a baseline setting step after said actual evaluation step, said actual mechanical response signal as said baseline signal to be used in a subsequent evaluation step to form a floating baseline signal.

13. The system according to claim 11, wherein
said target unit is a unit of a rail vehicle, said target unit, in particular, comprising a wheel unit, in particular, a wheel set, and/or wheel unit shaft and/or wheel unit axle and/or a drive unit and/or a drive motor unit and/or a drive gear unit and/or a wheel bearing unit and/or a running gear frame unit and/or a wagon body unit and/or a suspension unit and/or a current collector unit and/or a compressor unit and/or an electrical equipment unit, in particular a transformer unit and/or a converter unit;
said target unit is a wheel unit, in particular, a wheel set, of a rail vehicle and at least one mechanical wave generator unit and/or at least one mechanical wave detector unit is connected to an end section of a wheel unit shaft of said wheel unit;
said target unit is a unit of a motor vehicle, in particular, a structural unit of a power train and/or a running gear and/or a bodywork of said motor vehicle;
said target unit is a unit of an airplane, in particular, a structural unit of a power train and/or a running gear and/or a bodywork of said airplane;
said target unit is a unit of a ship, in particular, a structural unit of a power train and/or a bodywork of said ship;
said target unit is a unit of an industrial machine, in particular, a structural unit of a power train and/or a support structure of said industrial machine;
said target unit is a unit of a building, in particular, a structural unit of a support structure of said building;
said target unit is a unit of a tubing network, in particular, at least one tube of said tubing network;
said target unit is a unit of a storage tank or pressure tank, in particular, at least one wall of said tank;
said target unit is a unit of a wind energy plant, in particular, an electrical equipment unit of said wind energy plant and/or a structural unit of a pylon or a housing or a gear or a rotor component of said wind energy plant;
said target unit is a spacecraft, in particular, a structural unit of a bodywork of said spacecraft;
or
said target unit is a unit of a military tank, in particular, a structural unit of a power train or a running gear or a bodywork of said military tank.

14. The system according to claim 11, wherein
said at least one mechanical wave generator unit, said at least one mechanical wave detector unit, and said control unit are configured to perform at least one execution of said evaluation cycle during normal operation of said target unit;
said at least one mechanical wave generator unit, said at least one mechanical wave detector unit, and said control unit are configured to perform a batch of differential feature establishment cycles within an evaluation period, said batch of differential feature establishment cycles comprising a plurality of executions of said differential feature establishment cycle, said control unit in particular, being configured to determine said structural state in said evaluation step as a function of an evaluation result of at least one previous differential feature establishment cycle of said batch of differential feature establishment cycles;
said at least one mechanical wave generator unit, said at least one mechanical wave detector unit, and said control unit are configured to perform a batch of differential feature establishment cycles within an evaluation period, said batch of differential feature establishment cycles comprising a plurality of executions of said differential feature establishment cycle, at least two executions of said differential feature establishment cycle, preferably each execution of said differential feature establishment cycle, occurring at substantially identical values of at least one first boundary condition parameter and/or at different values of at least one second boundary condition parameter;
or
said target unit is a wheel unit of a rail vehicle comprising a wheel unit shaft, said at least one mechanical wave generator unit and/or said at least one mechanical wave detector unit being mechanically connected to said wheel unit shaft, in particular, at an end section of said wheel unit shaft, said at least one mechanical wave generator unit, said at least one mechanical wave detector unit, and said control unit being configured to perform a batch of differential feature establishment cycles within an evaluation period, said batch of differential feature establishment cycles comprising a plurality of executions of said differential feature establishment cycle, at least two executions of said differential feature establishment cycle, preferably each execution of said differential feature establishment cycle, occurring at different rotation angles of said wheel unit about an axis of rotation defined by said wheel unit shaft, said different rotation angles varying by 1° to 180°, preferably by 20° to 120°, more preferably by 45° to 90°.

15. A target unit, in particular a vehicle, comprising a system according to claim 11.

16. The method according to claim 1, wherein, said at least one reference is formed exclusively from said previous differential feature.
